(19) United States
(12) Patent Application Publication
(10) Pub. No.: US 2004/0081111 A1
(43) Pub. Date: Apr. 29, 2004

(54) Method for providing simplex broadcasting services in a mobile communication system

(75) Inventors: Beom-Sik Bae, Suwon-shi (KR); Chang-Hoi Koo, Songnam-shi (KR); Dae-Gyun Kim, Songnam-shi (KR); Jung-Su Jung, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/637,854

(22) Filed: Aug. 8, 2003

(30) Foreign Application Priority Data
Oct. 8, 2002 (KR) P2002-47319

(51) Int. Cl. H04L 12/28

(52) U.S. Cl. 370/316

(57) ABSTRACT

In a high-speed wireless packet data communication system, a simplex broadcasting service method sequentially assigns and releases a forward traffic channel and a reverse traffic channel for receiving information necessary for a PPP connection and a broadcasting service in order to receive a broadcasting service. In addition, transmission order of unicast data packets and broadcast data packets is determined in a physical layer in order to efficiently provide a unicast service and a broadcasting service. The method prevents a waste of wireless resources and power consumption of an access terminal by minimizing reservation of wireless resources and transmission of unnecessary information, thereby contributing to improvement of system performance.

### PRIORITY

This application claims priority under 35 U.S.C. § 119 to an application entitled “Method for Providing Simplex Broadcasting Service in a Mobile Communication System” filed in the Korean Intellectual Property Office on Aug. 10, 2002 and assigned Serial No. 2002-47319, the contents of which are incorporated herein by reference.

### BACKGROUND OF THE INVENTION

1. Field of the Invention

The present invention relates generally to a high-speed wireless packet data communication system, and in particular, to a method for providing simplex broadcasting services.

2. Description of the Related Art

A CDMA (Code Division Multiple Access)-2000 1× system, which has evolved from a typical 2^{nd} generation CDMA system, can provide a wireless data service as well as a voice service at a maximum of 144 Kbps, faster than a rate of 14.4 Kbps or 56 Kbps of the existing CDMA system. In particular, a CDMA2000 1×EVDO (Evolution Data Only) system has been proposed as a supplemental solution for high-speed data transmission in the IMT (International Mobile Telecommunications)-2000 class, and can support megaclass high-speed data transmission, using new technology for assigning the entire system resources only for the data service. Such a CDMA2000 1×EVDO system supports packet-based high-speed duplex data communication.

The CDMA2000 1×EVDO system, aimed at providing a high-speed duplex data service, supports only a unicast mode in which an access network (AN) transmits packet data only to a specific access terminal (AT). Such a unicast mode has been designed to provide a duplex service (or interactive service) that simultaneously requires a forward channel and a reverse channel. In order to identify ATs, a forward link uses a unicast MAC (Medium Access Control) index and a reverse link uses UATI (Unicast Access Terminal Identifier). In addition, an access network receives a response to a forward channel assignment request from an AT over a reverse traffic channel. For this reason, a conventional system must always simultaneously connect or release a forward traffic channel and a reverse traffic channel.

In addition, with the development of mobile communication systems, there are increasing demands for a multimedia service, a broadcasting service, a multicast service, etc., and in order to support such services, research has been carried out on methods of assigning addresses, such as ATI (Access Terminal Identifiers), and a MAC index, and a scheme for supporting a duplex multimedia service.

Newly required multimedia services include a service that requires duplex (or bi-directional) traffic transmission, such as an image communication service, and a service that can be implemented with only simplex (unidirectional) traffic transmission, such as a broadcasting service. That is, the broadcasting service is classified into a duplex broadcasting service and a simplex broadcasting service, and of the services, the simplex broadcasting service requires only a forward broadcast traffic channel and does not require a separate reverse traffic channel. An AT requesting a broadcasting service transmits information necessary for service request, authentication, and location registration to an access network over an access channel or a reverse traffic channel, and receives broadcast data as a response over a forward traffic channel assigned thereto. While receiving the broadcast data, the AT, if necessary, transmits data or a control message to the access network over the access channel.

As described above, the simplex service is not required to use a reverse traffic channel. However, as stated above, the CDMA2000 1×EVDO system supporting only unicast reserves wireless resources for a reverse traffic channel and transmits unnecessary signaling information even during a broadcasting service, resulting in a waste of wireless resources of an access network and power of an access terminal. In addition, the unnecessary information transmitted over a wireless channel affects traffic on other forward and reverse channels, increasing interference to neighbor cells and thus reducing an overall system performance.

### SUMMARY OF THE INVENTION

It is, therefore, an object of the present invention to provide a method for providing a simplex service in a high-speed wireless packet data communication system.

It is another object of the present invention to provide a method for providing an efficient simplex service while maintaining an existing system structure in a high-speed wireless packet data communication system.

It is further another object of the present invention to provide a method for connecting and releasing a simplex service in a high-speed wireless packet data communication system.

It is yet another object of the present invention to provide a method for reducing power consumption of an access terminal when providing a simplex service in a high-speed wireless packet data communication system.

It is still another object of the present invention to provide a method for reducing a waste of wireless resources when providing a simplex service in a high-speed wireless packet data communication system.

It is still another object of the present invention to provide a method for improving system performance by reducing interference when providing a simplex service in a high-speed wireless packet data communication system.

It is still another object of the present invention to provide a method for efficiently transmitting a unicast packet and a broadcast service packet in a physical layer to support a broadcasting service in a high-speed wireless packet data communication system.

It is still another object of the present invention to provide a method for performing periodic transmission, non-periodic transmission, and composite transmission of a broadcast service packet in a high-speed wireless packet data communication system.

In accordance with a first aspect of the present invention, there is provided a method for providing a broadcasting service to an access terminal in a high-speed wireless packet data communication system. The method comprises the steps of: sending a request for initiating the broadcasting service from the access terminal to an access network; assigning by the access network a forward traffic channel for the broadcasting service in response to the request; setting up by the access terminal a forward traffic channel in response to a broadcast traffic channel assignment message, and receiving the broadcasting service over the set forward traffic channel; sending by the access terminal a request for closing the broadcasting service to the access network while receiving the broadcasting service over the set forward traffic channel; and closing by the access network the broadcasting service for the access terminal in response to the broadcast service close request.

In accordance with a second aspect of the present invention, there is provided a method for providing a broadcasting service to an access terminal in a high-speed wireless packet data communication system. The method comprises the steps of: sending a request for initiating a broadcasting service from the access terminal to an access network; assigning by the access network a forward traffic channel and a reverse traffic channel to the access terminal in response to the request; setting up point-to-point protocol (PPP) connection for the broadcasting service through the forward traffic channel and the reverse traffic channel by the access terminal and the access network; receiving, by the access terminal, information necessary for the broadcasting service from the access network, and setting up a broadcast service channel using the received broadcast service information; releasing by the access terminal the forward traffic channel and the reverse traffic channel, and receiving the broadcasting service over the set broadcast service channel; sending by the access terminal a request for closing the broadcasting service to the access network while receiving the broadcasting service over the set broadcast service channel; and closing by the access network the broadcasting service for the access terminal in response to the broadcast service close request.

In accordance with a third aspect of the present invention, there is provided a method for providing a broadcasting service to an access terminal in a high-speed wireless packet data communication system. The method comprises the steps of: transmitting information necessary for the broadcasting service from an access network to the access terminal; sending by the access terminal a request for initiating the broadcasting service to the access network using the broadcast service information; assigning by the access network a forward traffic channel and a reverse traffic channel to the access terminal in response to the request; setting up point-to-point (PPP) connection for the broadcasting service through the forward traffic channel and the reverse traffic channel by the access terminal and the access network; setting up by the access terminal a broadcast service channel using the broadcast service information, releasing the forward traffic channel and the reverse traffic channel, and then receiving the broadcasting service over the set broadcast service channel at a PPP connection phase; sending by the access terminal a request for closing the broadcasting service to the access network while receiving the broadcasting service over the set broadcast service channel; and closing the broadcasting service for the access terminal in response to the broadcast service close request.

In accordance with a fourth aspect of the present invention, there is provided a method for transmitting by an access network a broadcast service packet to an access terminal in a high-speed wireless packet data communication system. The method comprises the steps of: determining every time slot of a forward traffic channel whether it is a broadcast service time previously assigned to have a predetermined period; determining whether it is a retransmission time of a previous encoded packet, if it is the broadcast service time; discarding a previous encoded packet and transmitting a broadcast service packet, if it is the retransmission time of a previous encoded packet; and transmitting a broadcast service packet, if it is not a retransmission time of a previous encoded packet.

In accordance with a fifth aspect of the present invention, there is provided a method for transmitting by an access network a broadcast service packet to an access terminal in a high-speed wireless packet data communication system. The method comprises the steps of: determining every time slot of a forward traffic channel whether it is a retransmission time of a previous encoded packet; determining whether it is a broadcast service time previously assigned to have a predetermined period, if it is not the retransmission time of the previous encoded packet; selecting a new encoded packet through scheduling and transmitting the selected new encoded packet, if it is not the broadcast service time; and transmitting a broadcast service packet, if it is the broadcast service time.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates an overall configuration of a broadcasting service system to which the present invention is applied;

FIG. 2 is a message flow diagram illustrating an operation of assigning a traffic channel for unicast communication;

FIG. 3 illustrates a format of a Connection Request message;

FIG. 4 illustrates a format of a Traffic Channel Assignment message;

FIG. 5 is a message flow diagram illustrating an operation of releasing a traffic channel assigned through unicast communication;

FIG. 6 illustrates a format of a Connection Close message;

FIG. 7 illustrates a slot format of a forward link in a CDMA2000 1×EVDO system;

FIG. 8 illustrates an example of transmitting unicast data over forward channels in a CDMA2000 1×EVDO system;

FIG. 9 is a flowchart illustrating an operation of transmitting an encoded packet over a forward channel in an access network;

FIG. 10 is a message flow diagram illustrating an operation of assigning a traffic channel for a simplex broadcasting service according to a first embodiment of the present invention;

FIG. 11 illustrates a format of an improved Connection Request message;

FIG. 12 illustrates a format of a Broadcast Traffic Channel Assignment message;

FIG. 13 is a message flow diagram illustrating an operation of releasing an assigned forward traffic channel according to a first embodiment of the present invention;

FIG. 14 illustrates a format of an improved Connection Close message;

FIG. 15 is a message flow diagram illustrating an operation of assigning a traffic channel for a simplex broadcasting service according to a second embodiment of the present invention;

FIG. 16 illustrates a format of a Broadcast Service Information message, which is a dedicated message;

FIG. 17 illustrates a format of a Broadcast Service Information message, which is an overhead message;

FIG. 18 is a message flow diagram illustrating an operation of releasing an assigned traffic channel according to a second embodiment of the present invention;

FIG. 19 is a message flow diagram illustrating an operation of assigning a traffic channel for a simplex broadcasting service according to a third embodiment of the present invention;

FIG. 20 is a message flow diagram illustrating an operation of releasing an assigned traffic channel according to a third embodiment of the present invention;

FIG. 21 illustrates an example of transmitting forward traffic for providing a broadcasting service according to an embodiment of the present invention;

FIG. 22 is a flowchart illustrating an operation of periodically transmitting an encoded packet over a forward traffic channel;

FIG. 23 illustrates another example of transmitting forward traffic for providing a broadcasting service according to an embodiment of the present invention; and

FIG. 24 is a flowchart illustrating an operation of non-periodically transmitting an encoded packet over a forward traffic channel.

### DETAILED DESCRIPTION OF THE PREFERRED EMBODIMENT

Several preferred embodiments of the present invention will now be described in detail herein below with reference to the annexed drawings. In the following description, a detailed description of known functions and configurations incorporated herein has been omitted for conciseness. The terms used herein are defined in view of functions in the present invention, and can be changed according to a user, an intention of the user, or usual practice. Therefore, the definition should become different based on the contents throughout the specification.

The present invention provides a simplex broadcasting service requiring only a forward channel in a high-speed wireless packet data communication system, and also provides a method for transmitting a packet in a physical layer to efficiently provide a common unicast service and a simplex broadcasting service.

Herein, the present invention will be described with reference to an IS-2000 1×EVDO (Evolution Data Only) system, which is a synchronous CDMA (Code Division Multiple Access) communication system. However, it would be obvious to those skilled in the art that the simplex broadcasting service method proposed by the invention can also be applied to other mobile communication systems having the similar technical background and channel format without departing from the spirit and scope of the invention.

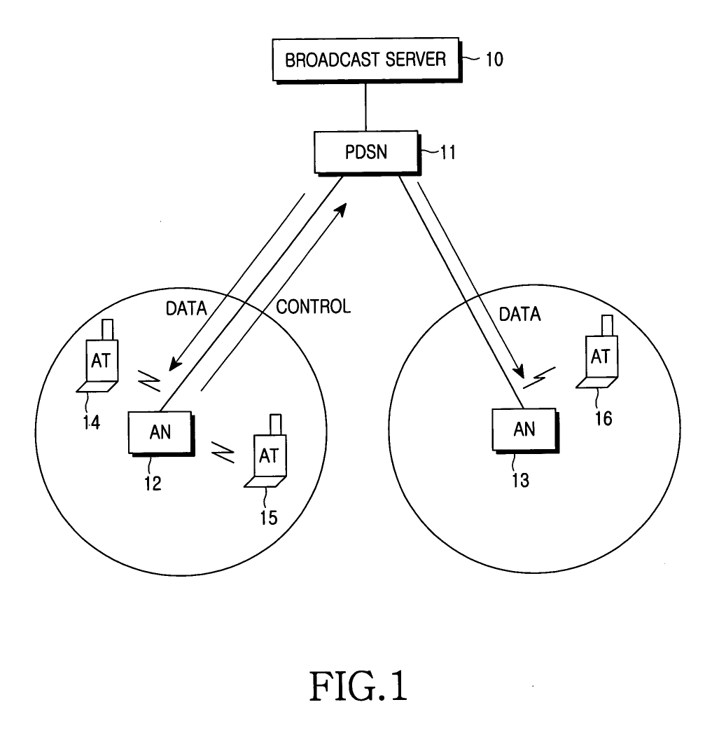

FIG. 1 illustrates an overall configuration of a broadcasting service system to which the present invention is applied. Referring to FIG. 1, a broadcast server 10 generates image and voice data (i.e., broadcast data) for a broadcasting service, and delivers the image and voice data to a plurality of access networks (ANs) 12 and 13 via a packet data service node (PDSN) 11. The image and voice data arrived at the access networks 12 and 13 is radiated to a plurality of access terminals (ATs) 14, 15, and 16 in the form of a radio frequency (RF) signal. Users watch a broadcasting service through a display and a speaker of the access terminals 14, 15, and 16.

When the packet data service node 11 is connected to the broadcast server 10 via a packet communication network (not shown) such as the Internet, the image and voice data has a type of a compressed Internet protocol (IP) packet. The access terminals 14, 15, and 16 then receive the image and voice data via PPP (Point-to-Point Protocol) connection.

The access networks 12 and 13 connect forward (from AN to AT) wireless channels and reverse (from AT to AN) wireless channels to the access terminals 14, 15, and 16, transmit broadcast data over the forward channels, and receive control information over the reverse channels. The access networks 12 and 13 manage information on wireless channels connected to the access terminals accessing the access networks 12 and 13.

Shown in Table 1 below is information on wireless channels managed by an access network for an access terminal.

TABLE 1

| | Forward Traffic | Forward RPC Bit | Reverse Traffic |
|---|---|---|---|
| Unicast | DMAC Index | DMAC Index | UATI |
| System Info Tx | BMAC Index | | |
| | (BATI) | | |

Referring to Table 1, an access network manages a dedicated MAC (DMAC) index of an access terminal for transmission of forward traffic. The DMAC index is used as a code mask to distinguish reverse power control (RPC) bits for each access terminal. UATI (Unicast Access Terminal Identifier) uniquely assigned to each access terminal includes information on a subnet where the access terminal is located, and is used as a long code mask (LCM) for enabling an access network to distinguish reverse transmission by access terminals during transmission of reverse traffic.

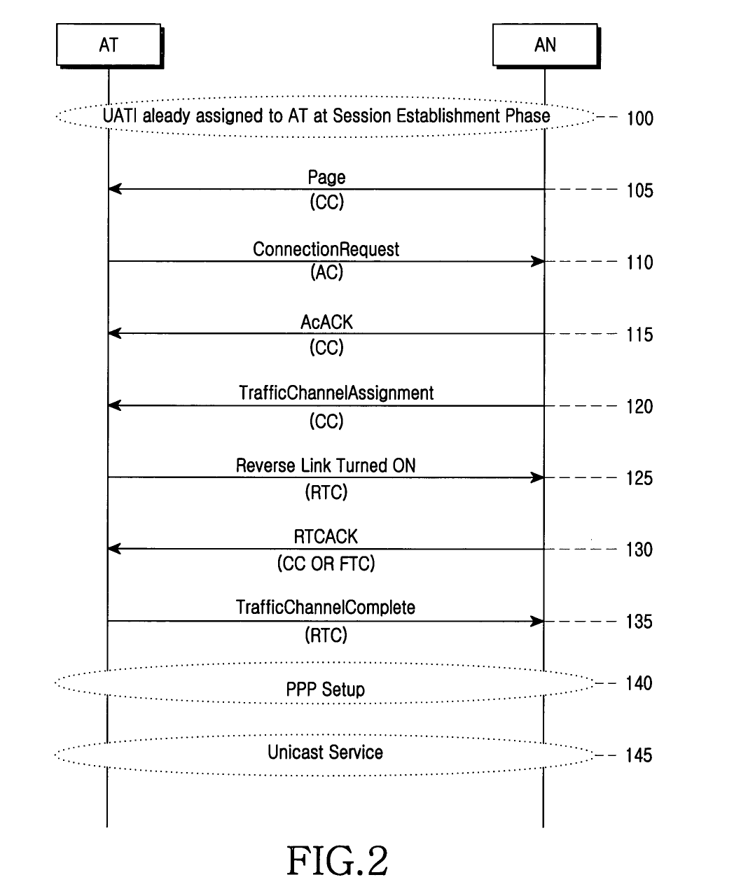

FIG. 2 is a message flow diagram illustrating a common operation of assigning a traffic channel for unicast communication. Herein, channels over which messages are transmitted are marked in parentheses. For example, “CC” represents a control channel, “AC” represents an access cannel, “RTC” represents a reverse traffic channel, and “FTC” represents a forward traffic channel.

Referring to FIG. 2, in step 100, an access network (AN) establishes a session between the access network and an access terminal (AT), and assigns UATI to the access terminal at the established session phase. In step 105, the access network transmits a Page message for requesting call connection for a unicast data service, to the access terminal over a control channel. A destination (or reception) address of the Page message is set to UATI of the access terminal.

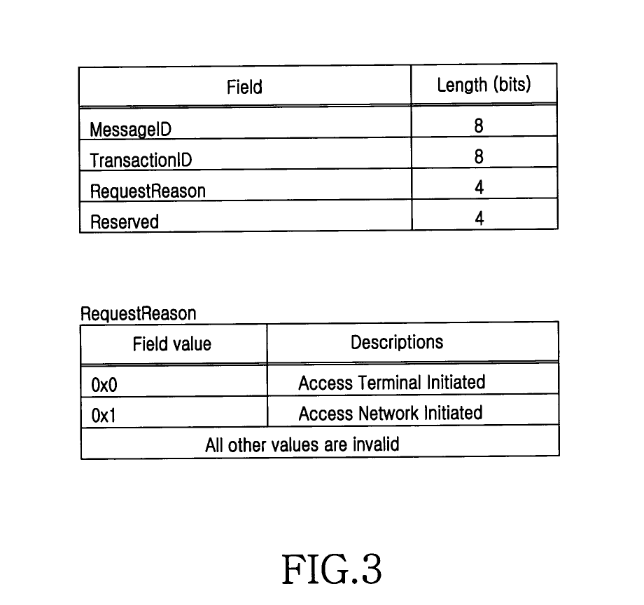

In step 110, the access terminal transmits a Connection Request message to the access network in response to the Page message. The Connection Request message is masked with a long code mask generated based on the assigned UATI, and then transmitted over an access channel. The Connection Request message, as illustrated in FIG. 3, includes an 8-bit Message ID field, an 8-bit Transaction ID field, and a 4-bit Request Reason field. When the access terminal requests call connection, the access terminal can immediately transmit the Connection Request message to the access network without receiving the Page message in step 105. Therefore, the Request Reason field in the Connection Request message is set to a value of ‘0×0’ indicating ‘AT initiated’, or a value of ‘0×1’ indicating ‘AN initiated’.

When the Connection Request message is successfully received, in step 115, the access network transmits AcACK indicating an acknowledge (ACK) for the access channel to the access terminal over a control channel. In step 120, the access network assigns a forward traffic channel and a reverse traffic channel to be used by the access terminal, and then transmits a Traffic Channel Assignment message indicating the assignment result to the access terminal over a control channel. The Traffic Channel Assignment message includes both information necessary for forward traffic transmission and information necessary for reverse traffic transmission, so that the forward traffic channel and the reverse traffic channel are simultaneously assigned.

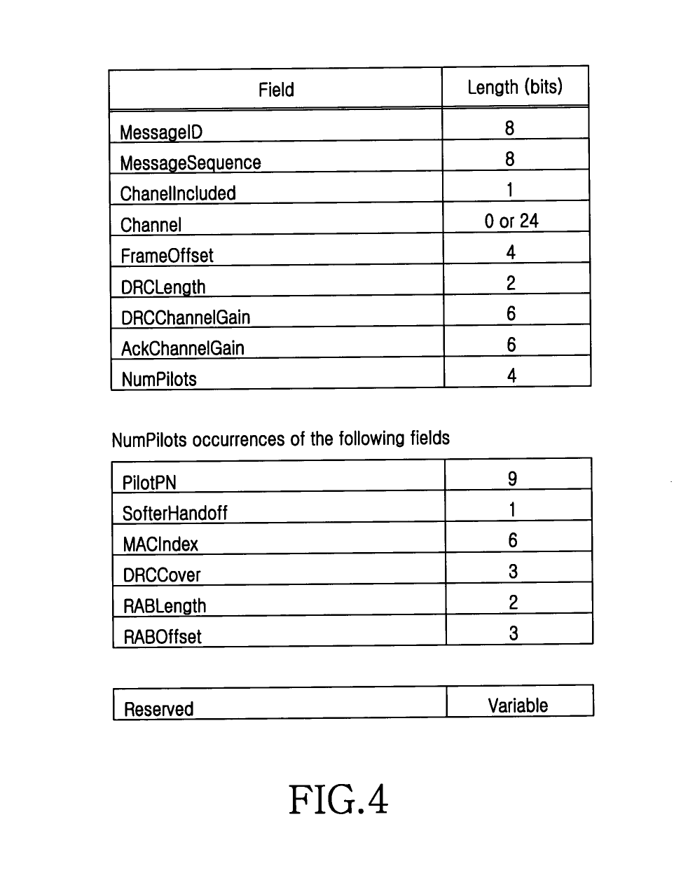

The Traffic Channel Assignment message, as illustrated in FIG. 4, includes a Frame Offset field, a Pilot Pseudo-random Noise Code (Pilot PN) information field, and a MAC Index field as forward traffic channel information, and includes a DRC (Data Rate Control) information Length field, a DRC Channel Gain field, an ACK Channel Gain field, a DRC Cover code field, a RAB (Reverse Activity Bit) information Length field, and a RAB Offset field as reverse traffic channel information.

In step 125, the access terminal activates a forward traffic channel and a reverse traffic channel using forward traffic channel information and reverse traffic channel information included in the Traffic Channel Assignment message, and transmits null traffic data over the reverse traffic channel. When the null traffic data is successfully detected from the reverse traffic channel, the access network transmits, in step 130, an RTCACK message responsive to the reverse traffic channel to the access terminal over a control channel or a forward traffic channel. A destination address of the RTCACK message is set to UATI of the access terminal or a MAC Index.

When the RTCACK message is successfully received, the access terminal transmits, in step 135, a Traffic Channel Complete message indicating completion of the traffic channel assignment procedure, to the access network over a reverse traffic channel. The access network and the access terminal set up PPP (Point-to-Point Protocol) connection through the assigned reverse and forward traffic channels in step 140, and then bi-directionally exchange data traffics through the PPP connection in step 145.

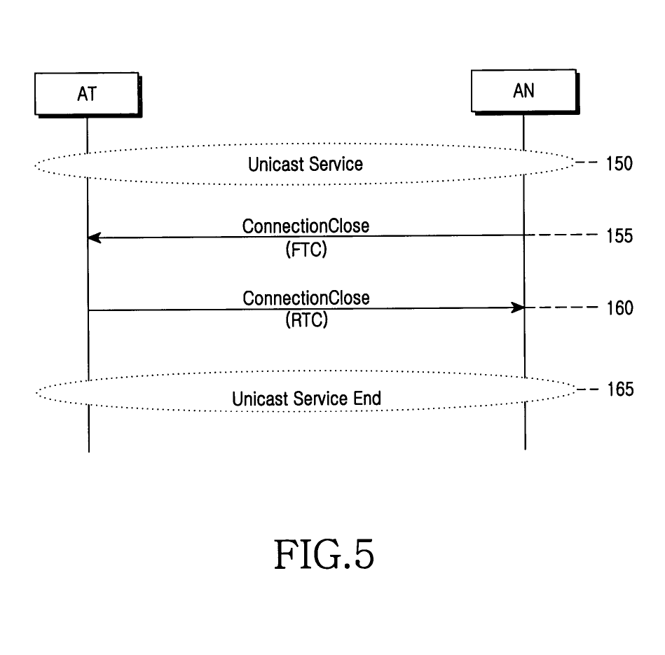

FIG. 5 is a message flow diagram illustrating an operation of releasing a traffic channel assigned through the procedure illustrated in FIG. 2. Likewise, channels over which messages are transmitted are marked in parentheses.

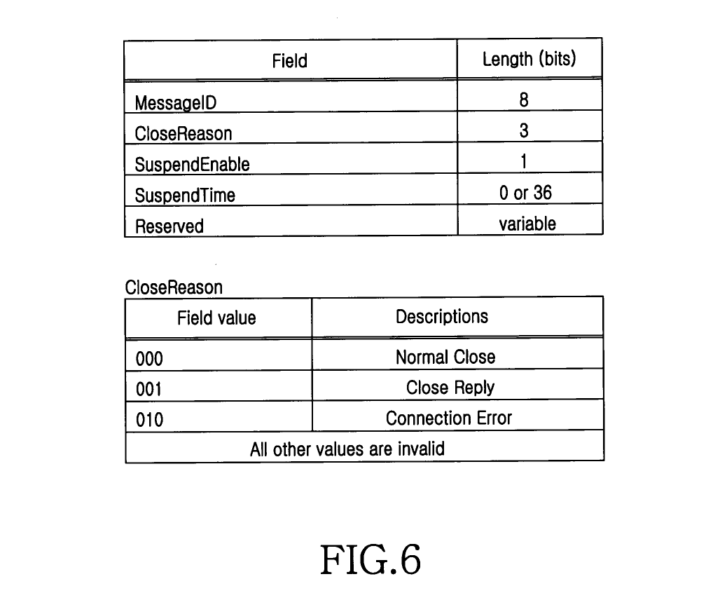

Referring to FIG. 5, in step 150, an access network and an access terminal connect a unicast service and bi-directionally exchange data traffic over a forward traffic channel and a reverse traffic channel. When the access network desires to close data transmission and release the traffic channels, it transmits a Connection Close message to the access terminal over the forward traffic channel in step 155. Upon receiving the Connection Close message, the access terminal transmits, in step 160, a Connection Close message to the access network over the reverse traffic channel and then releases the forward traffic channel and the reverse traffic channel. The Connection Close message, as illustrated in FIG. 6, includes a 3-bit Close Reason field. The Close Reason field is set to a value indicating any one of a general close acknowledge and a connection error.

When the traffic channels are released at the request of the access terminal, the access terminal immediately transmits the Connection Close message to the access network without receiving the Connection Close message of the step 155. In step 165, the access network receives the Connection Close message and releases the forward traffic channel and the reverse traffic channel, thereby ending the unicast service.

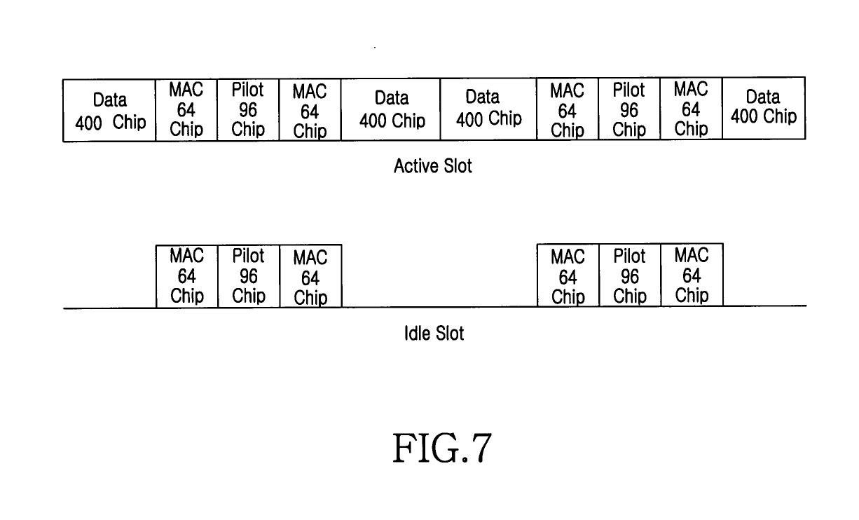

In the CDMA2000 1×EVDO system, a forward link separates forward channels by physical time division multiplexing (TDM). FIG. 7 illustrates a slot format of a forward link in the CDMA2000 1×EVDO system. As illustrated, one 2048-chip slot is divided into two half (½) slots, and in an active state, each ½ slot sequentially delivers 400-chip data, 64-chip MAC information, 96-chip pilot, 64-chip MAC information, and 400-chip data. The data includes data traffic or a signaling message, and the MAC information includes control information, such as a MAC index and a data rate. The MAC information and the pilot are always transmitted at a fixed position every ½ slot, and in an idle state where there is no data to transmit, only the MAC information and the pilot are transmitted at a predetermined position.

Here, a time period assigned to the data becomes a forward traffic channel, a time period assigned to the MAC information becomes a MAC channel, and a time period assigned to the pilot becomes a pilot channel. In addition, in previously assigned slots, a time period assigned to the data is used as a control channel for transmitting control information. That is, an access network transmits control information rather than data every tens or hundreds of slots.

The control channel is used to deliver a control message of an access network or a system parameter message to a specific or every access terminal in an active state or an idle state within the same cell. Here, BATI (Broadcast Access Terminal Identifier) is used as a destination address of the system parameter message transmitted to every access terminal, and when the system parameter message is delivered, MAC information transmitted over a MAC channel is set to a broadcast MAC (BMAC) index in a forward channel.

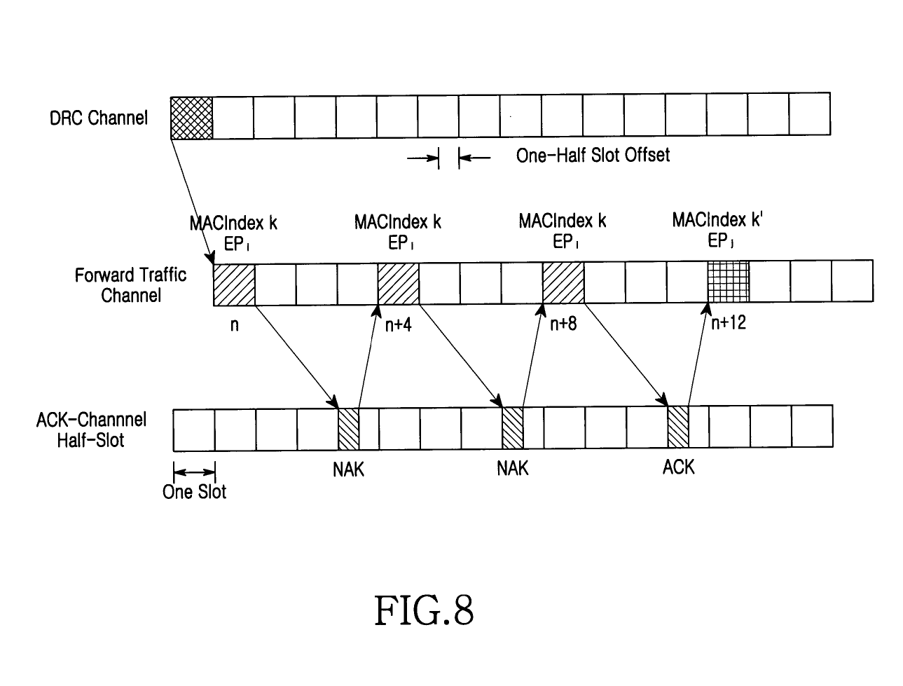

FIG. 8 illustrates an example of transmitting unicast data through a forward link formed as illustrated in FIG. 7. An access terminal periodically transmits DRC (Data Rate Control) information to an access network. The access network then selects an access terminal scheduled to use a current slot, by scheduling transmission of forward packet data. In FIG. 8, an access terminal with a MAC index k is selected for a slot #n. The access network then determines a data rate to be applied to the access terminal with the MAC index k according to the DRC information, and transmits an encoded packet (EP) EPi to the access terminal with the MAC index k according to the determined data rate. At this point, the access network informs the selected access terminal of the assigned MAC index k and the determined data rate through a MAC channel,

The access terminal decodes the encoded packet EPi received over the forward traffic channel only when a MAC index assigned thereto is received over the MAC channel. If the encoded packet EPi is decoded successfully, the access terminal transmits an acknowledge (ACK) to the access network over an ACK channel. Otherwise, the access terminal transmits a non-acknowledge (NAK) to the access network.

When a NAK is received in response to the encoded packet EPi, the access network retransmits the encoded packet EPi at a 4^{th} slot #(n+4) after previous transmission. If the NAK is received again in response to the retransmission, the access network retransmits the encoded packet EPi at a slot #(n+8). If ACK is received for the retransmitted encoded packet EPi, the access network ends transmission of the encoded packet EPi and then selects a new encoded packet to be transmitted to another access terminal, i.e., an encoded packet EPj to be transmitted to an access terminal with a MAC index k', by scheduling. The new encoded packet EPj is transmitted at a slot #(n+12).

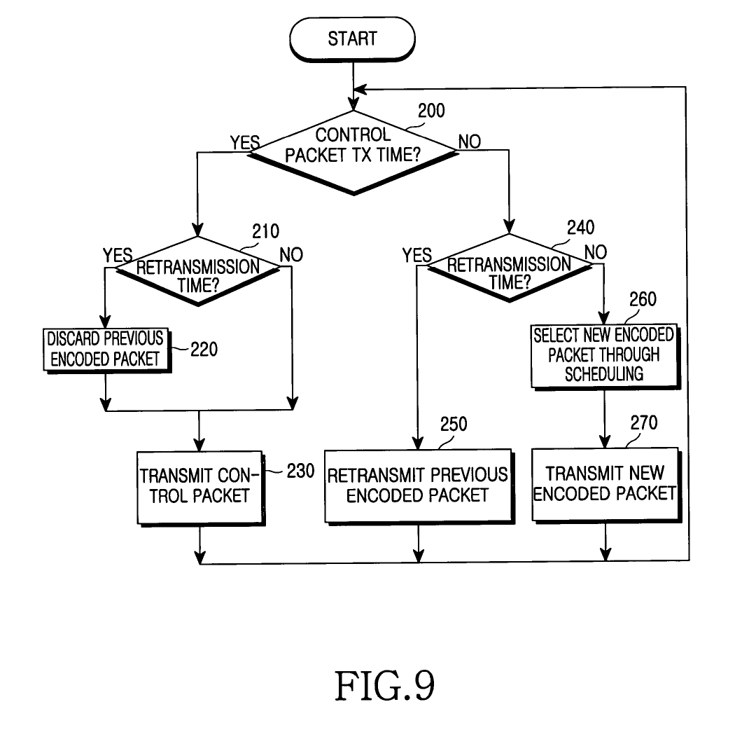

FIG. 9 is a flowchart illustrating an operation of transmitting an encoded packet over a forward channel in an access network. The term “encoded packet” as used herein refers to data traffic delivered over a traffic channel, and the term “control packet” refers to a signaling message delivered over a control channel. When an encoded packet is retransmitted as described in conjunction with FIG. 8, an access network must repeatedly retransmit the encoded packet every four slots. Therefore, the access network must determine whether it must transmit a control packet, retransmit the failed encoded packet, or transmit a new encoded packet through scheduling, in the method described below.

Referring to FIG. 9, in step 200, an access network determines at every slot start time whether it is a transmission time of a control packet. That is, the access network determines whether a current slot is a slot previously assigned to a control channel. If it is a transmission time of a control packet, the access network determines in step 210 whether it is a retransmission time of a previous encoded packet. That is, the access network determines whether NAK was received for a previously transmitted encoded packet and, if so, determines whether a current slot is a 4^{th} slot after previous transmission. If it is a transmission time of a control packet and also it is a retransmission time of a previous encoded packet, the access network discards the previous encoded packet in step 220 and then transmits a control packet in step 230. If it is a transmission time of a control packet but it is not a retransmission time of a previous encoded packet, the access network transmits a control packet in step 230.

However, if it is not a transmission time of a control packet in step 200 but it is a retransmission time of a previous encoded packet in step 240, the access network retransmits the previous encoded packet in step 250. Further, if it is not a transmission time of a control packet and also it is not a retransmission time of a previous encoded packet, the access network selects an access terminal, to which a new encoded packet is to be transmitted, by scheduling in step 260, and then transmits the new encoded packet to the selected access terminal in step 270.

Unlike the unicast service that uses both a forward traffic channel and a reverse traffic channel, most broadcasting services are a simplex service that requires only a forward traffic channel. That is, most traffic for a broadcasting service is transmitted from an access network to an access terminal, and the other data such as control information and a signaling message necessary for a simplex broadcasting service can be transmitted in both a forward direction and a reverse direction.

In order to provide a simplex service such as a broadcasting service, an access network manages information on wireless channels for an access terminal, as illustrated in Table 2 below.

TABLE 2

| | | Forward | Reverse |
|---|---|---|---|
| | Forward Traffic | RPC Bit | Traffic |
| Unicast | DMAC Index | DMAC Index | UATI |
| System Info Tx | BMAC Index (MATI) | | |
| Broadcasting Service | BMAC Index | | UATI |

Compared with Table 1, Table 2 further includes information on a broadcast service channel. That is, in a simplex broadcasting service, an access network uses a broadcast MAC (BMAC) index or a multicast MAC (MMAC) index for forward traffic transmission, and an access terminal receives broadcast data over a forward traffic channel using the broadcast MAC index. In the simplex broadcasting service, in order to transmit data and a control message in a reverse direction, an access channel or a reverse traffic channel, which is temporarily connected only when necessary, is used. The access terminal generates a long code mask (LCM) using UATI, and transmits a message masked with the long code mask over an access channel.

Connection and Release of Broadcasting Service

In order to enable a simplex service in a communication system based on duplex communication, a description will be made herein regarding an improved Connection Request message, an improved Connection Close message, a newly designed Broadcast Traffic Channel Assignment message, and a newly designed Broadcast Service Information message. However, names and formats of the messages can be replaced with other names and other formats having the same function. In addition, although the invention will be described herein with reference to a fundamental procedure necessary for connecting and releasing a broadcasting service, the invention can further include other procedures necessary for system realization.

Herein, a new procedure for connecting and releasing a broadcasting service according to the present invention will be separately described with reference to a case where PPP connection is not required (first embodiment), a case where PPP connection is required (second embodiment), and a case where transmission of an overhead message is required before PPP connection (third embodiment).

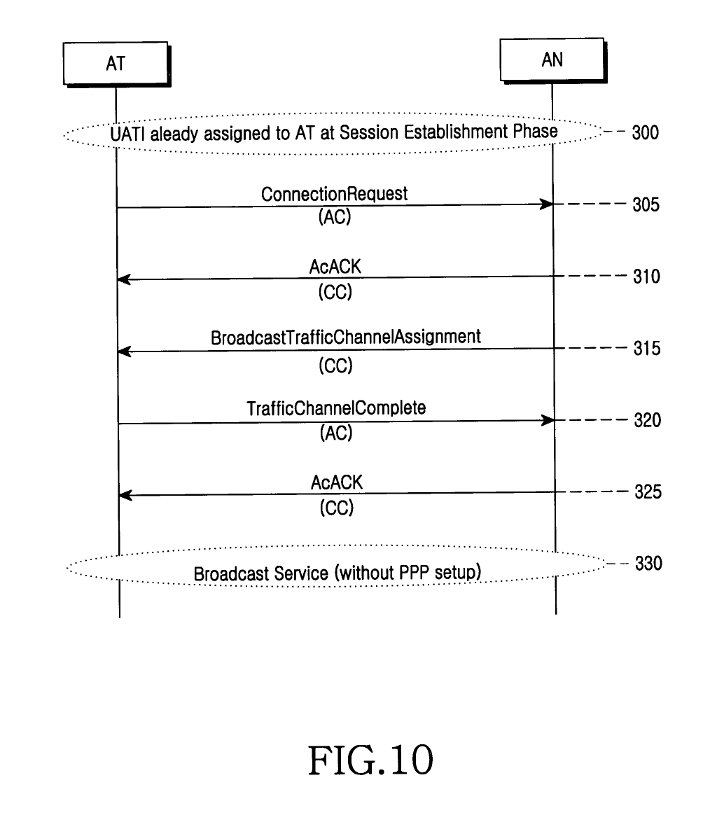

FIG. 10 is a message flow diagram illustrating an operation of assigning a traffic channel for a simplex broadcasting service according to a first embodiment of the present invention. Here, a simplex broadcasting service that does not require PPP connection is provided.

Referring to FIG. 10, in step 300, an access network (AN) establishes a session between the access network and an access terminal (AT), and assigns UATI to the access terminal at the established session phase. In step 305, the access terminal transmits a Connection Request message requesting call connection for a broadcasting service, to the access network. In a simplex broadcasting service, it is common that an access terminal requests call connection. However, when a broadcasting service is initiated at the request of an access network, the access network can induce the step 305 by transmitting a Page message to the access terminal. In this case, a destination address of the Page message is set to UATI of the access terminal, and fields for representing the broadcasting service is included therein.

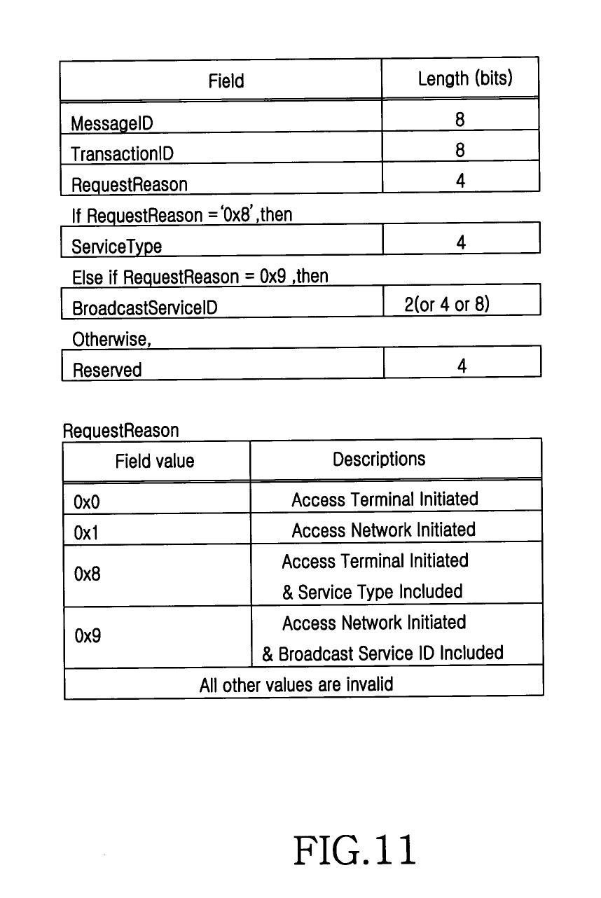

The Connection Request message is masked using a long code mask generated based on the assigned UATI and then transmitted over an access channel. A format of the Connection Request message improved for a broadcasting service is illustrated in FIG. 11. Compared with FIG. 3, FIG. 11 further includes a 4-bit Service Type field, or a 2, 4, or 8-bit Broadcast Service ID field according to the contents (‘0×8’ or ‘0×9’) of a Request Reason field.

The Service Type field distinguishes a service type, and the Broadcast Service ID field distinguishes a simplex broadcast service channel. The Broadcast Service ID field represents predetermined services, represents a stream ID marked on a stream header according to a stream type determined during session setup, or represents a service index received through an overhead message. In addition, the Request Reason field represents whether the connection request is initiated by an access terminal (‘0×0’ or ‘0×8’), or by an access network (‘0×1’ or ‘0×9’).

When the Connection Request message is successfully received, the access network transmits AcACK indicating an acknowledge (ACK) for the access channel to the access terminal over a control channel in step 310. Thereafter, the access network analyzes the Connection Request message, and if it is determined that a simplex broadcasting service was requested, i.e., if a Service Type field being set to a value indicating a simplex broadcasting service is included, then the access network transmits, in step 315, a Broadcast Traffic Channel Assignment message indicating assignment of a forward traffic channel for a broadcasting service (hereinafter referred to as a “broadcast service channel”), to the access terminal over a control channel.

If the Connection Request message is an initial broadcast service request received from the access network, the access network must newly assign a forward traffic channel for a broadcast channel. However, because this is not related to the present invention, a detailed description thereof will be omitted.

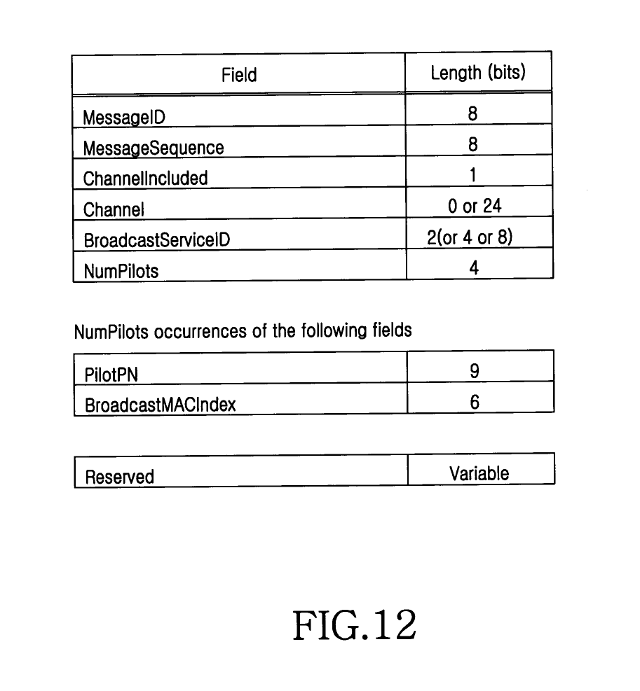

Unlike the conventional unicast or duplex service, the simplex broadcasting service does not require a reverse channel, so the Broadcast Traffic Channel Assignment message includes only the information for forward traffic transmission. FIG. 12 illustrates a format of the Broadcast Traffic Channel Assignment message. Compared with the Traffic Channel Assignment message illustrated in FIG. 4, the Broadcast Traffic Channel Assignment message illustrated in FIG. 12 includes a 2, 4, or 8-bit Broadcast Service ID, a 6-bit Broadcast MAC (BMAC) Index (or MMAC Index) being used in a corresponding cell and neighbor cells for a simplex broadcasting service, and a 9-bit Pilot PN code information. The BMAC Index (or MMAC Index) can have different values for respective cells and sectors, like the DMAC Index.

Although the Broadcast Traffic Channel Assignment message illustrated in FIG. 12 includes only the information necessary for forward traffic transmission, when a reverse traffic channel is added for performance improvement, it can additionally include information on a reverse traffic channel.

In step 320, the access terminal activates a forward traffic channel in response to the Broadcast Channel Assignment message and transmits a Traffic Channel Complete message over an access channel. Upon receiving the Traffic Channel Complete message, the access network transmits, in step 325, an AcACK message for an access channel to the access terminal over a control channel, determining that establishment of a traffic channel is complete. A destination address of the AcACK message is set to UATI of the access terminal or a MAC Index. Thereafter, in step 330, the access terminal is provided with the simplex broadcasting service over the forward traffic channel.

When the access terminal desires to transmit data in a reverse direction during the simplex broadcasting service, if a unicast reverse traffic channel is temporarily set up and transmission of necessary data is completed, the reverse traffic channel is released.

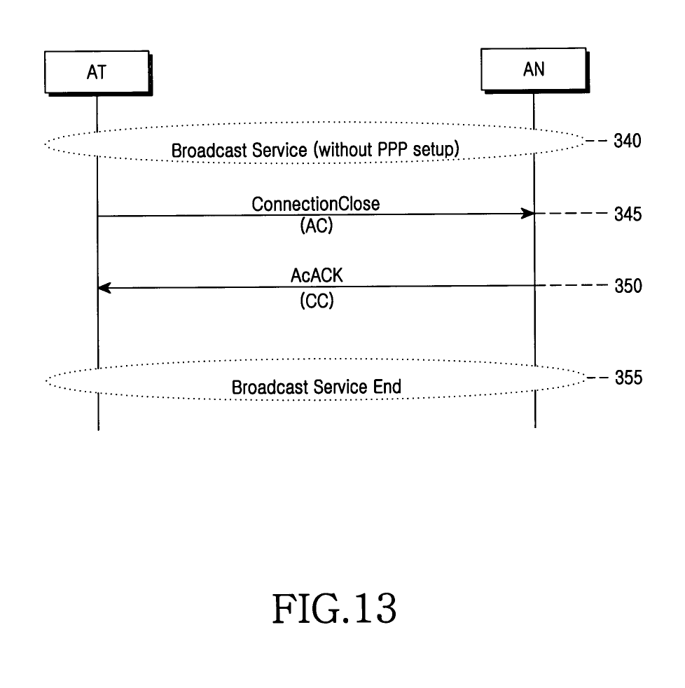

FIG. 13 is a message flow diagram illustrating an operation of releasing a forward traffic channel assigned through the procedure illustrated in FIG. 10. Referring to FIG. 13, in step 340, an access terminal receives data traffic for a broadcasting service from an access network over a broadcast service channel. When the access terminal desires to close the broadcasting service, it transmits, in step 345, a Connection Close message to the access network over an access channel, and then releases the broadcast service channel. When closing the broadcasting service at the request of the access network, the access network induces the step 345 by transmitting a Connection Close message to the access terminal.

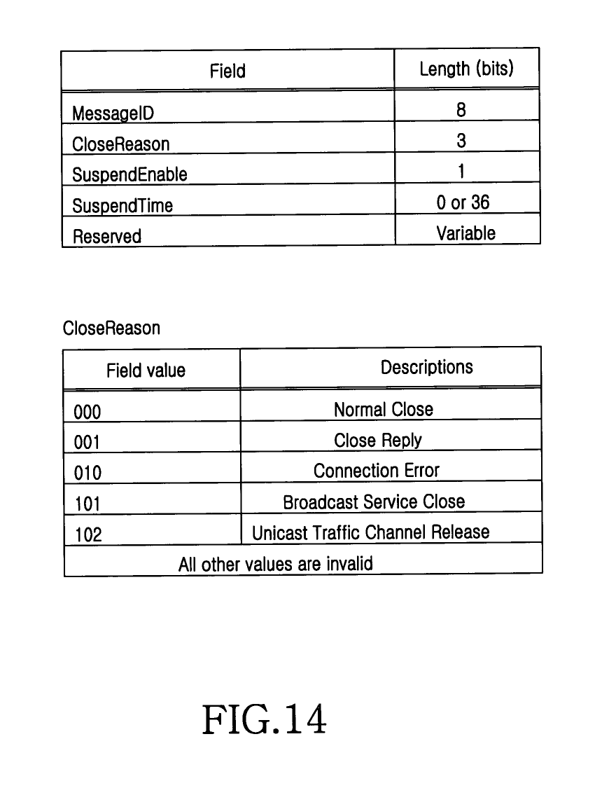

FIG. 14 illustrates an improved format of the Connection Close message. Compared with the Connection Close message illustrated in FIG. 6, the Connection Close message of FIG. 14 adds a value ‘101’ indicating ‘Broadcast Service Close’ and a value ‘102’ indicating ‘Unicast Traffic Channel Release’ to a Close Reason field.

If the access network receives the Connection Close message with the Close Reason field set to ‘101’ indicating ‘Broadcast Service Close’ and then transmits AcACK to the access terminal in response to the received Connection Close message in step 350, a simplex broadcasting service of the access terminal is ended in step 355. In another case, if the Close Reason field of the Connection Close message is set to a value ‘102’ indicating ‘Unicast Traffic Channel Release’, every connection between the access network and the access terminal is closed.

If there are no more access terminals being provided with a broadcasting service from the access network, the access network will release a forward traffic channel for the broadcasting service. However, because this is not a main purpose of the present invention, a detailed description thereof will be omitted.

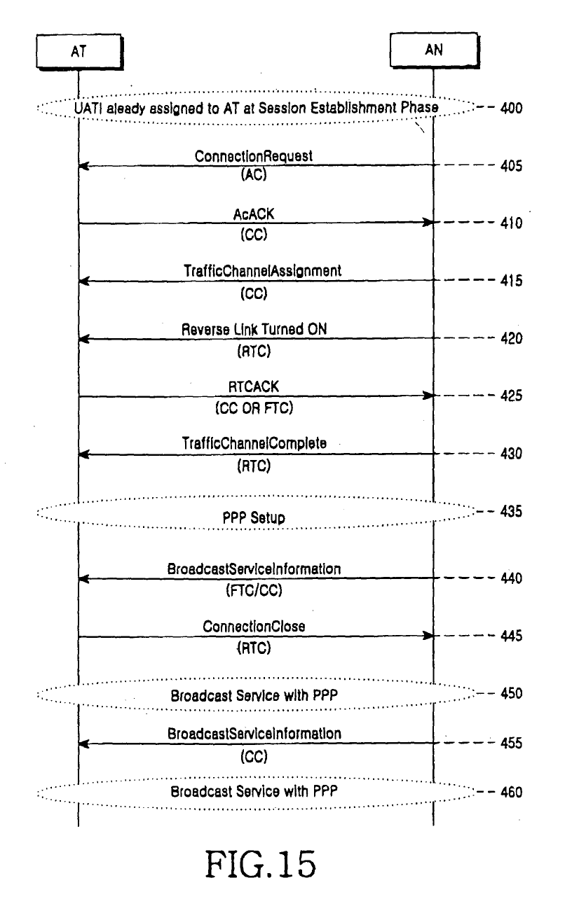

FIG. 15 is a message flow diagram illustrating an operation of assigning a traffic channel for a simplex broadcasting service according to a second embodiment of the present invention. Herein, in order to provide a simplex broadcasting service that requires PPP connection, forward and reverse traffic channels are first assigned to establish PPP connection.

Referring to FIG. 15, in step 400, an access network (AN) establishes a session between the access network and an access terminal (AT), and assigns UATI to the access terminal at the established session phase. In order to initiate a broadcasting service through the PPP connection at the request of the access terminal, the access terminal transmits, in step 405, a Connection Request message for requesting call connection for a broadcasting service to the access network. The Connection Request message, as described above, has the format illustrated in FIG. 11, and includes information for requesting a broadcasting service. The Connection Request message is masked with a long code mask (LCM) generated using the assigned UATI to be transmitted over an access channel. When the broadcasting service is initiated at the request of the access network, the access network can induce the step 405 by transmitting a Page message to the access terminal.

When the Connection Request message is successfully received, the access network transmits AcACK to the access terminal over a control channel in step 410. Thereafter, the access network analyzes the Connection Request message, and if it is determined that a simplex broadcasting service was requested, i.e., if a Service Type field being set to a value indicating a simplex broadcasting service is included, then the access network assigns a forward traffic channel and a reverse traffic channel to be used by the access terminal and transmits a Traffic Channel Assignment message indicating the assignment result to the access terminal over a control channel in step 415.

The Traffic Channel Assignment message includes all the information necessary for forward and reverse traffic transmission to be used for a general unicast or duplex service, and has the format illustrated in FIG. 4. It should be noted that a forward traffic channel and a reverse traffic channel assigned by the Traffic Channel Assignment message are not for the broadcasting service itself, but for setting up the PPP connection.

In step 420, the access terminal activates a forward traffic channel and a reverse traffic channel in response to the Traffic Channel Assignment message, and transmits null traffic data over the reverse traffic channel. When the null traffic data transmitted by the access terminal is successfully detected, the access network transmits, in step 425, an RTCACK message for the reverse traffic channel to the access terminal over a control channel or a forward traffic channel. A destination address of the RTCACK message is set to UATI of the access terminal or a MAC Index.

When the RTCACK message is successfully received, the access terminal transmits, in step 430, a Traffic Channel Complete message indicating completion of the traffic channel assignment procedure, to the access network over a reverse traffic channel. When the Traffic Channel Complete message is received, the access network sets up a PPP (Point-to-Point Protocol) connection to the access terminal through the assigned reverse and forward traffic channels in step 430, determining that establishment of the traffic channels is complete. Herein, the PPP connection is set up between an access terminal and a broadcast server via an access network and a packet data service node.

In step 440, the access network transmits a Broadcast Service Information message including information necessary for a simplex broadcasting service to the access terminal over a forward traffic channel or a control channel. The simplex broadcasting service information is provided from the broadcast server, and means broadcast contents and broadcast channels. Therefore, the access terminal selects a broadcasting service on a desired channel referring to the broadcast contents, and then starts receiving the selected broadcasting service over a corresponding broadcast service channel.

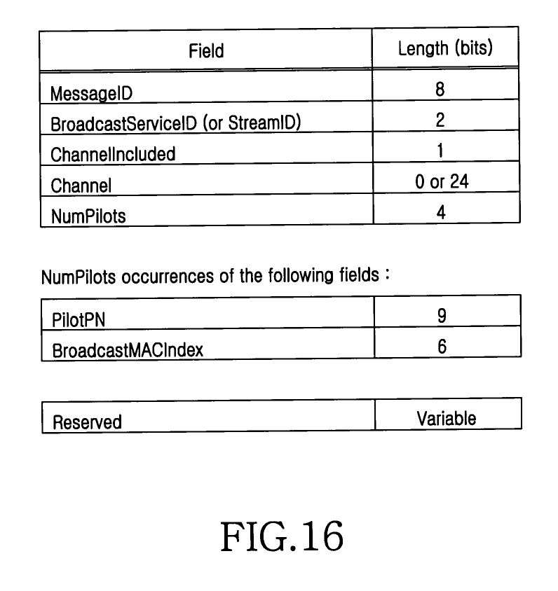

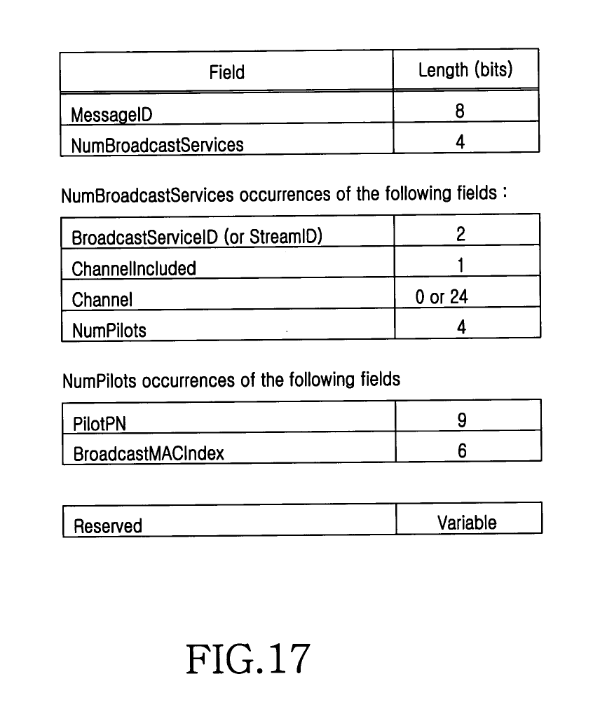

The Broadcast Service Information message can become a type of a dedicated message or an overhead message, and is transmitted over a control channel or a forward traffic channel. FIG. 16 illustrates a format of the Broadcast Service Information message, which is a dedicated message. Referring to FIG. 16, the Broadcast Service Information message includes a Broadcast Service ID (or Stream ID), a Broadcast MAC (BMAC) Index, and broadcast channel information. In addition, FIG. 17 illustrates a format of the Broadcast Service Information message, which is an overhead message. Referring to FIG. 17, the Broadcast Service Information message includes a Broadcast Service ID (or Stream ID), a Broadcast MAC (BMAC) Index, and broadcast channel information according to a ‘Number of Broadcast Services’ field.

In step 445, the access terminal transmits a Connection Close message for releasing the traffic channels used in step 415 for the PPP connection setup, to the access network over a reverse traffic channel. The Connection Close message has the format illustrated in FIG. 14, and its Close Reason field is set to a value ‘102’ indicating release of a unicast traffic channel. In response, the access network releases the traffic channels used for the PPP connection setup, and then performs a broadcasting service through the set PPP connection in step 450.

Even during the simplex broadcasting service, at the request of the broadcast server, the access network transmits, in step 455, additional information necessary for the broadcasting service to the access terminal over a control channel, using a Broadcast Service Information message having the format illustrated in either FIG. 16 or FIG. 17.

When the access terminal desires to transmit data in a reverse direction during the simplex broadcasting service, if a unicast reverse traffic channel is temporarily set up and transmission of necessary data is completed, the reverse traffic channel is released.

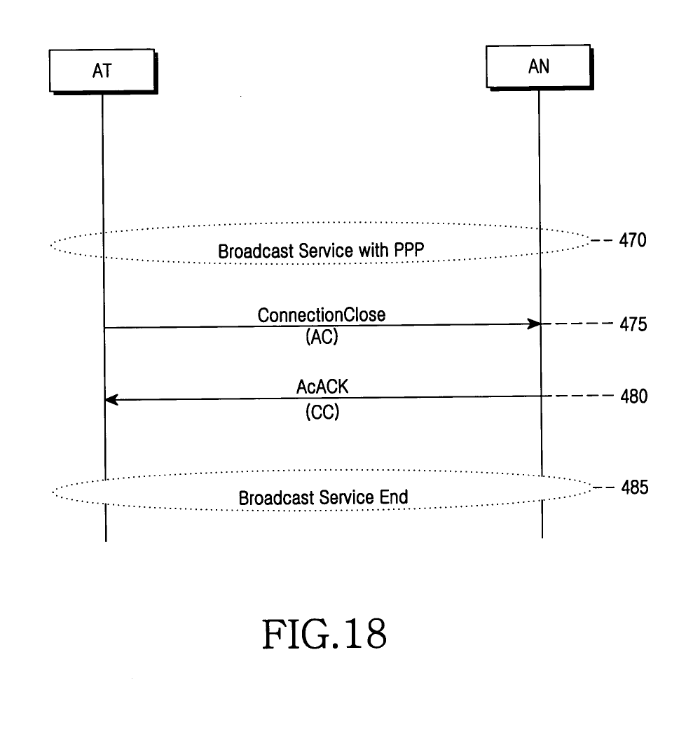

FIG. 18 is a message flow diagram illustrating an operation of releasing a traffic channel assigned through the procedure illustrated in FIG. 15. Referring to FIG. 18, in step 470, an access terminal receives data traffic for a broadcasting service from an access network over a broadcast service channel. When the access terminal desires to close the broadcasting service, it transmits, in step 475, a Connection Close message to the access network over an access channel, and then releases the broadcast service channel. A format of the Connection Close message is illustrated in FIG. 14, and its Close Reason field is set to a value ‘101’ indicating close of the broadcasting service. When closing the broadcasting service at the request of the access network, the access network induces the step 475 by transmitting a Connection Close message to the access terminal. If the access network receives the Connection Close message and then transmits AcACK in response to the received Connection Close message in step 480, the simplex broadcasting service is ended in step 485.

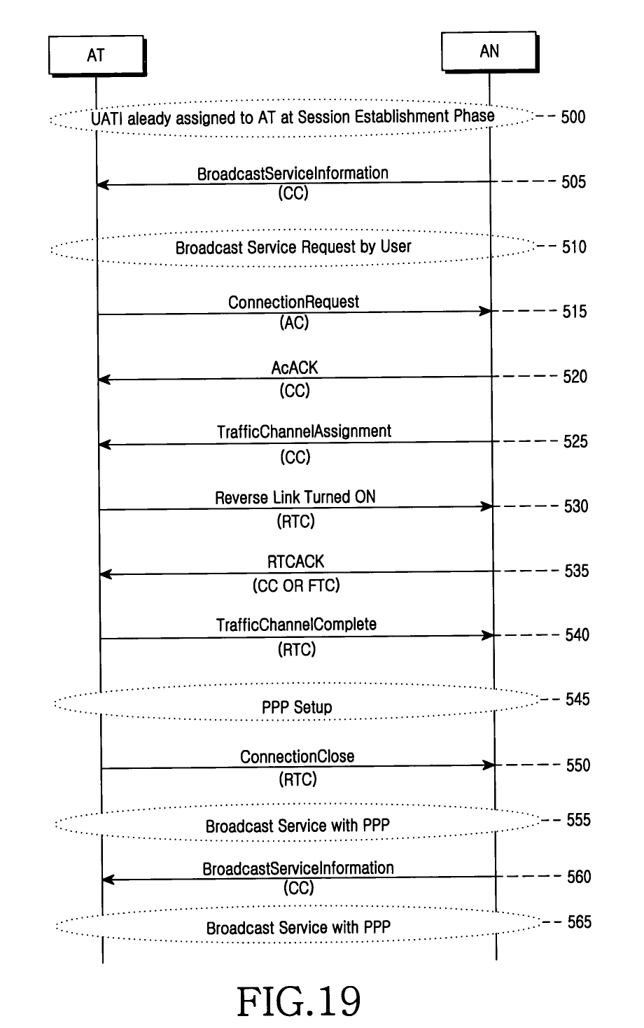

FIG. 19 is a message flow diagram illustrating an operation of assigning a traffic channel for a simplex broadcasting service according to a third embodiment of the present invention. Herein, the simplex broadcasting service requires a PPP connection, and an access network periodically or non-periodically transmits an overhead message in a connected state or a disconnected state.

Referring to FIG. 19, in step 500, an access network (AN) establishes a session between the access network and an access terminal (AT), and assigns UATI to the access terminal at the established session phase. In step 505, the access network transmits information necessary for a simplex broadcasting service to the access terminal over a control channel, using a Broadcast Service Information message. The Broadcast Service Information message, as described above, has the format illustrated in FIG. 16 or FIG. 17. Here, the simplex broadcasting service information is physical fundamental information for receiving a broadcasting service, broadcast contents provided from a broadcast server, and broadcast channels.

If a user requests a desired broadcasting service according to the received Broadcast Service Information message in step 510, the access terminal transmits, in step 515, a Connection Request message for requesting call connection for a broadcasting service to the access network. The Connection Request message, as described above, has the format illustrated in FIG. 11, and includes information for requesting the broadcasting service requested by the user. The Connection Request message is masked with a long code mask (LCM) generated using the assigned UATI to be transmitted over an access channel. In an alternative case, the access network induces the step 505 by transmitting a Page message to the access terminal.

When the Connection Request message is successfully received, the access network transmits AcACK to the access terminal over a control channel in step 520. Thereafter, the access network analyzes the Connection Request message, and if it is determined that a simplex broadcasting service was requested, i.e., if a Service Type field being set to a value indicating a channel for a simplex broadcasting service is included, then the access network assigns a forward traffic channel and a reverse traffic channel to be used by the access terminal and transmits a Traffic Channel Assignment message indicating the assignment result to the access terminal over a control channel in step 525. The Traffic Channel Assignment message includes all the information necessary for forward and reverse traffic transmission to be used for a general unicast or duplex service, and has the format illustrated in FIG. 4.

In step 530, the access terminal activates a forward traffic channel and a reverse traffic channel in response to the Traffic Channel Assignment message, and transmits null traffic data over the reverse traffic channel. When the null traffic data transmitted by the access terminal is successfully detected, the access network transmits, in step 535, an RTCACK message for the reverse traffic channel to the access terminal over a control channel or a forward traffic channel. A destination address of the RTCACK message is set to UATI of the access terminal or a MAC Index.

When the RTCACK message is successfully received, the access terminal transmits, in step 540, a Traffic Channel Complete message indicating completion of the traffic channel assignment procedure, to the access network over a reverse traffic channel. When the Traffic Channel Complete message is received, the access network sets up a PPP (Point-to-Point Protocol) connection through the assigned reverse and forward traffic channels in step 545, determining that establishment of the traffic channels is complete. Herein, the PPP connection is set up between an access terminal and a broadcast server via an access network and a packet data service node.

If the PPP connection is set up, the access terminal starts receiving the broadcasting service over a corresponding broadcast service channel according to the previously received broadcast service information. Thereafter, in step 550, the access terminal transmits a Connection Close message for releasing the traffic channels assigned for the PPP connection setup, to the access network over a reverse traffic channel. The Connection Close message has the format in FIG. 14, and its Close Reason field is set to a value ‘102’ indicating release of a unicast traffic channel. In response, the access network releases the traffic channels assigned for the PPP connection setup, and then performs a broadcasting service through the set PPP connection in step 555.

Even during the simplex broadcasting service, at the request of the broadcast server, the access network transmits, in step 560, additional information necessary for the broadcasting service to a specific access terminal or every access terminal within a cell over a control channel, using a Broadcast Service Information message having the format illustrated in either FIG. 16 or FIG. 17.

When the access terminal desires to transmit data in a reverse direction during the simplex broadcasting service, if a unicast reverse traffic channel is temporarily set up and transmission of necessary data is completed, the reverse traffic channel is released through the procedure illustrated in FIG. 5.

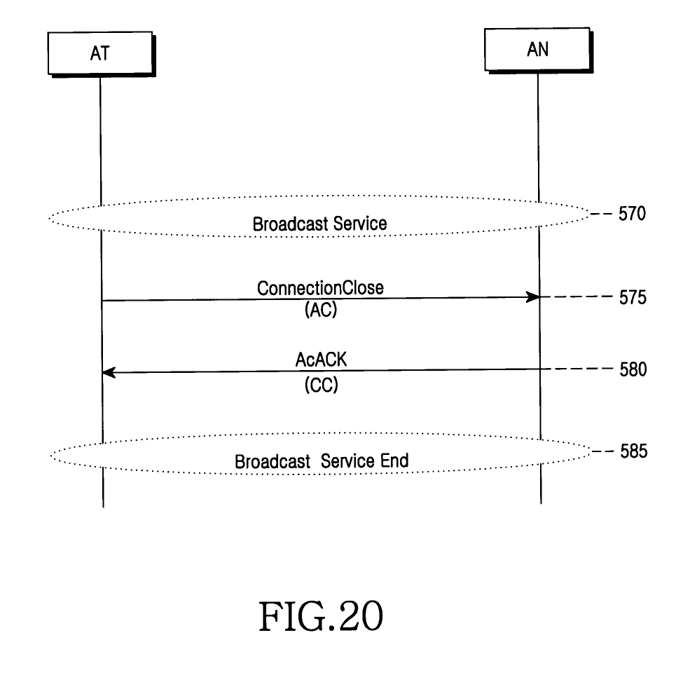

FIG. 20 is a message flow diagram illustrating an operation of releasing a traffic channel assigned through the procedure illustrated in FIG. 19. Referring to FIG. 20, in step 570, an access terminal receives data traffic for a broadcasting service from an access network over a broadcast service channel. When the access terminal desires to close the broadcasting service, it transmits, in step 575, a Connection Close message to the access network over an access channel, and then releases the broadcast service channel. A format of the Connection Close message is illustrated in FIG. 14, and its Close Reason field is set to a value ‘101’ indicating close of the broadcasting service. When closing the broadcasting service at the request of the access network, the access network induces the step 575 by transmitting a Connection Close message to the access terminal. If the access network receives the Connection Close message and then transmits AcACK to the access terminal in response to the received Connection Close message in step 580, the simplex broadcasting service is ended in step 585.

Transmission of Broadcast Data Traffic

When a forward traffic channel for a broadcasting service is connected in the above-described manner, an access network transmits broadcast traffic over the connected forward traffic channel. If a conventional unicast data service and a broadcasting service are simultaneously connected, the access network determines whether it will transmit unicast data or broadcast data every data transmission time. Herein, a procedure for transmitting data according to the invention will be separately described with reference to a case where broadcast data is periodically transmitted and another case where broadcast data is non-periodically transmitted.

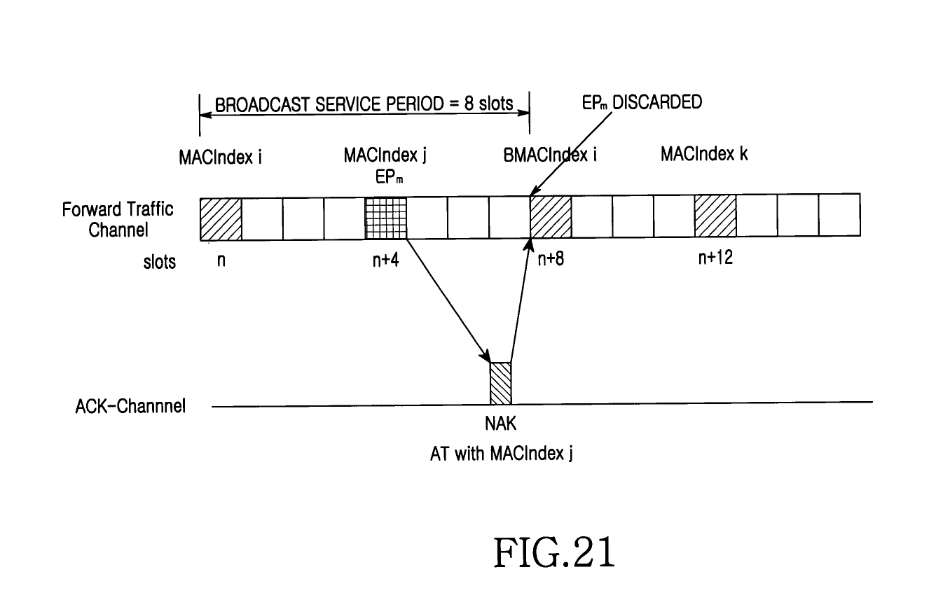

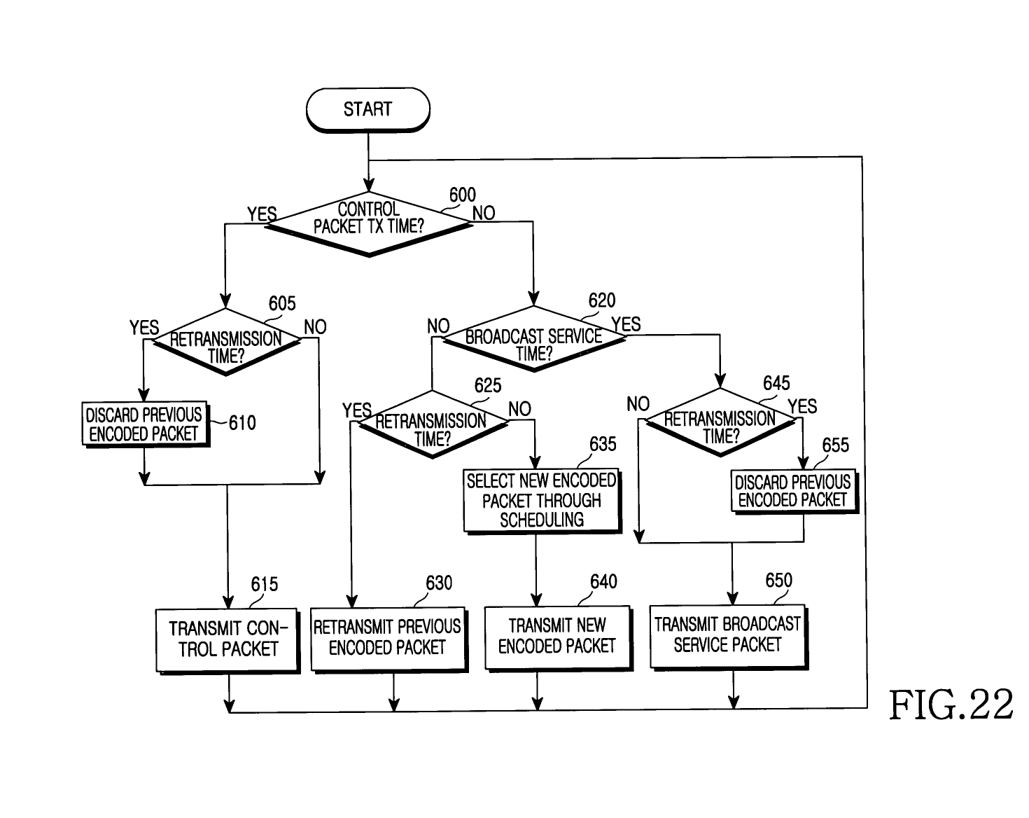

FIG. 21 illustrates an example of transmitting forward traffic for providing a broadcasting service according to an embodiment of the present invention. FIG. 22 is a flowchart illustrating an operation of transmitting an encoded packet over a forward traffic channel illustrated in FIG. 21. Herein, slots determined to have a specific period are assigned for a broadcasting service, and an encoded packet for a broadcasting service (hereinafter referred to as “broadcast service data”) is transmitted at the assigned slots. That is, at a slot assigned to the broadcasting service, even though there is a unicast encoded packet being waited to be retransmitted or an encoded packet with low priority, an access network discards the encoded packet rather than retransmitting the encoded packet, and then transmits a broadcast service packet. In this case, the encoded packet will be discarded or retransmitted by an upper layer. However, because this is not a main object of the present invention, a detailed description thereof will be omitted for simplicity.

Referring to FIG. 21, a broadcast service period has 8 slots, and a slot #n and a slot #(n+8) are assigned for the broadcasting service. First, at the slot #n of a forward traffic channel, a broadcast service packet with a BMAC Index i is transmitted to all access terminals. Thereafter, the access network transmits an encoded packet EPm to an access terminal with a MAC Index j at a slot #(n+4) of the forward traffic channel, and then receives NAK from the access terminal with a MAC Index j at a slot #(n+7) of an ACK channel in response to the encoded packet EPm. The encoded packet EPm must be retransmitted at a slot #(n+8) due to the NAK, but the slot #(n+8) is already assigned for the broadcasting service that is periodically transmitted. Therefore, the access network discards the encoded packet EPm, and then transmits a broadcast service packet with a BMAC Index i at the slot #(n+8). Thereafter, the access network transmits a new encoded packet to another access terminal with a MAC Index k at a slot #(n+12), or retransmits the encoded packet EPm when NAK for the encoded packet EPm is received.

An operation of transmitting an encoded packet over a forward traffic channel by an access network will now be described with reference to FIG. 22. Herein, the term “control packet” refers to a signaling message transmitted over a control channel, the term “encoded packet” refers to unicast data traffic, and the term “broadcast service packet” means an encoded packet for a broadcasting service.

Referring to FIG. 22, in step 600, an access network determines at every slot start time whether it is a transmission time of a control packet. Here, the “transmission time of a control packet” is a slot previously assigned to a control channel. If it is a transmission time of a control packet, the access network determines in step 605 whether it is a retransmission time of a previous encoded packet. That is, referring to FIG. 21, the access network determines whether a NAK was received for a previously transmitted encoded packet and, if so, determines whether a current slot is a 4^{th} slot after previous transmission. If it is a retransmission time of a previous encoded packet in step 605, the access network discards the previous encoded packet in step 610 and then transmits a control packet in step 615. However, if it is not a retransmission time of a previous encoded packet, the access network transmits a control packet in step 615.

However, if it is not a transmission time of a control packet in step 600, the access network determines in step 620 whether it is a broadcast service time. Here, the “broadcast service time” refers to a slot assigned to a broadcasting service. If it is a broadcast service time in step 620, the access network determines in step 645 whether it is a retransmission time of a previous encoded packet. If it is a broadcast service time but it is not a retransmission time of a previous encoded packet in step 645, the access network transmits a broadcast service packet in step 650. If it is a broadcast service time and also it is a retransmission time of a previous encoded packet in step 645, the access network discards the previous encoded packet in step 655, and then transmits a broadcast service packet in step 650.

If it is not a broadcast service time in step 620, but it is a retransmission time of a previous encoded packet in step 625, the access network retransmits the previous encoded packet in step 630. If it is not a broadcast service time and also it is not a retransmission time of a previous encoded packet in step 625, the access network selects an access terminal, to which a new encoded packet is to be transmitted, by scheduling in step 635, and then transmits the new encoded packet to the selected access terminal in step 640.

Although FIGS. 21 and 22 illustrate periodic transmission of broadcast traffic, the broadcast traffic can also be non-periodically transmitted. In this case, it is not necessary to early terminate transmission of an encoded packet for a unicast service. Also, it is possible to auxiliarily use partial-early termination for quality guarantee of a broadcasting service.

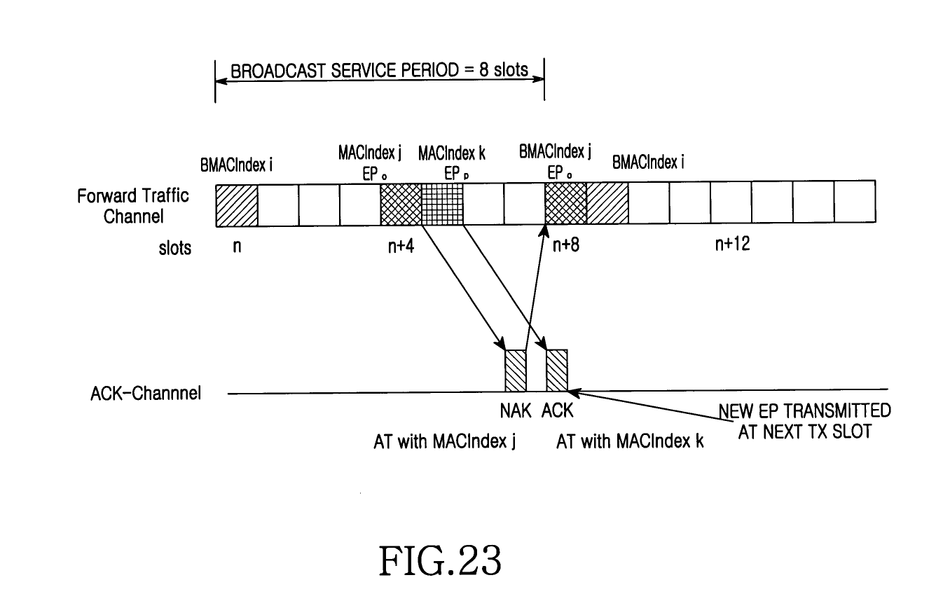

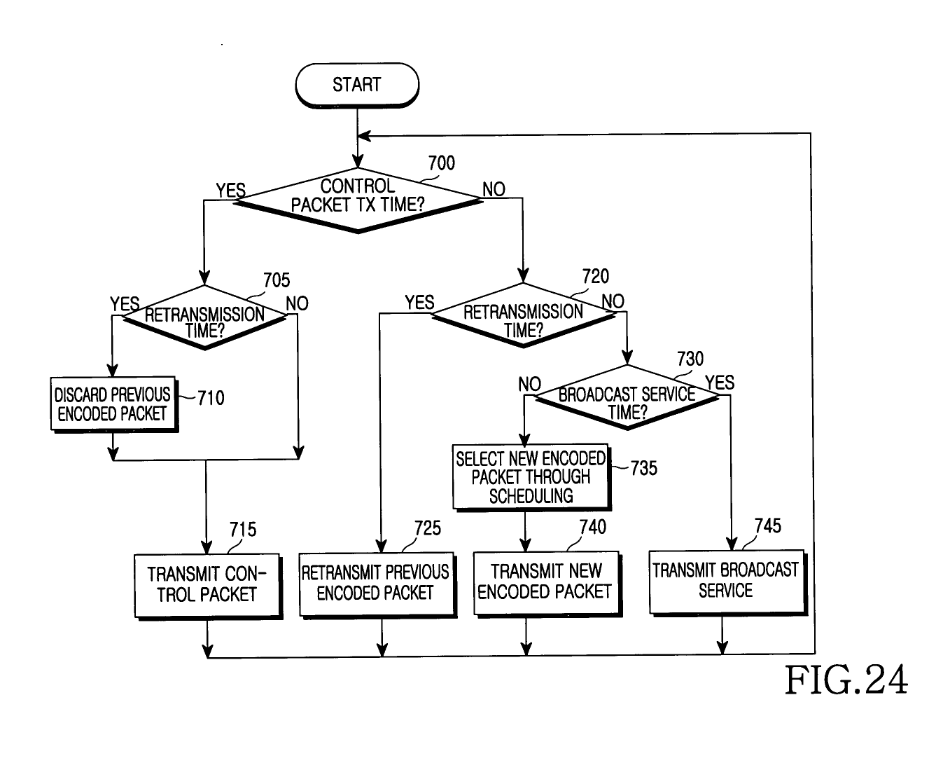

FIG. 23 illustrates another example of transmitting forward traffic for providing a broadcasting service according to an embodiment of the present invention, and FIG. 24 is a flowchart illustrating an operation of transmitting an encoded packet over a forward traffic channel illustrated in FIG. 23. Herein, a broadcast service packet is non-periodically transmitted within one transmission period (or transmission boundary) according to a transmission period determined in a physical layer. That is, if there is an encoded packet being waited to be retransmitted when it comes to a slot assigned to a broadcasting service, the encoded packet is first transmitted.

Referring to FIG. 23, a broadcast service period has 8 slots, and a slot #n and a slot #(n+8) are assigned for the broadcasting service. First, at the slot #n of a forward traffic channel, a broadcast service packet with a BMAC Index i is transmitted to all access terminals. In addition, the access network transmits an encoded packet EPo to an access terminal with a MAC Index j at a slot #(n+4) of the forward traffic channel, and transmits an encoded packet EPp to an access terminal with a MAC Index k at a slot #(n+5). Further, the access network receives a NAK from an access terminal with a MAC Index j at a slot #(n+7) of an ACK channel, and receives ACK from an access terminal with a MAC Index k at a slot #(n+8) of the ACK channel.

In this case, although the slot #(n+8) is assigned for the broadcasting service, the access network retransmits the encoded packet EPo to the access terminal with a MAC Index j at the slot #(n+8), and then transmits a broadcast service packet with a BMAC Index i instead of a new encoded packet at the next slot #(n+9). Here, the broadcast service packet can be transmitted within the 8-slot broadcast service period after the encoded packet EPo is initially transmitted.

An operation of transmitting an encoded packet over a forward traffic channel by an access network will now be described with reference to FIG. 24. Here, the term “control packet” refers to a signaling message transmitted over a control channel, the term “encoded packet” refers to unicast data traffic, and a “broadcast service packet” is an encoded packet for a broadcasting service.

Referring to FIG. 24, in step 700, an access network determines at every slot start time whether it is a transmission time of a control packet. If it is a transmission time of a control packet, the access network determines in step 705 whether it is a retransmission time of a previous encoded packet. That is, referring to FIG. 23, the access network determines whether a NAK was received for a previously transmitted encoded packet and, if so, determines whether a current slot is a 4^{th} slot after previous transmission.

If it is a transmission time of a control packet and also it is a retransmission time of a previous encoded packet in step 705, the access network discards the previous encoded packet in step 710 and then transmits a control packet in step 715. If it is a transmission time of a control packet but it is not a retransmission time of a previous encoded packet in step 705, the access network transmits a control packet in step 710.

Alternatively, if it is not a transmission time of a control packet in step 700, but it is a retransmission time of a previous encoded packet in step 720, the access network retransmits the previous encoded packet in step 725. Further, if it is not a transmission time of a control packet and also it is not a retransmission time of a previous encoded packet in step 720, the access network determines in step 730 whether it is a broadcast service time.

If it is not a broadcast service time in step 730, the access network selects an access terminal, to which a new encoded packet is to be transmitted, by scheduling in step 735, and then transmits the new encoded packet to the selected access terminal in step 740. However, it is a broadcast service time, the access network transmits a broadcast service packet in step 745.

Although a highest priority is given to a control packet and next highest priorities are given in order of a broadcast service packet, a retransmission packet, and a new encoded packet through scheduling in FIG. 24, the priorities can be changed at the request of a user or a system.

The periodic transmission method illustrated in FIGS. 21 and 22 is easy to implement but may reduce transmission efficiency of unicast traffic. Also, the non-periodic transmission method illustrated in FIGS. 23 and 24 may require a complicated scheduler and have a difficulty in guaranteeing QoS (Quality of Service) of the broadcasting service, and its implementation is complicated. In order to compensate for the drawbacks, it is possible to combine the periodic transmission method with the non-periodic transmission method. When one packet is made into an encoded packet comprised of a plurality of slots in the combined transmission method, the non-periodic transmission method is used during packet transmission and the periodic transmission method is used for an encoded packet that is transmitted over multiple slots.

The present invention as described above has many advantages. That is, the present invention prevents a waste of wireless resources of an access network and power consumption of an access terminal by preventing reservation of wireless resources for a reverse traffic channel and unnecessary transmission of signaling information during a simplex broadcasting service. In addition, the present invention reduces unnecessary information transmitted over a wireless channel, thereby reducing interference to neighbor cells and thus improving the overall system performance.

While the present invention has been illustrated and described with reference to a certain preferred embodiment thereof, it will be understood by those skilled in the art that various changes in form and details may be made therein without departing from the spirit and scope of the invention as defined by the appended claims.

What is claimed is:

1. A method for providing a simplex broadcasting service to an access terminal in a high-speed wireless packet data communication system, comprising the steps of:
(a) sending a request for initiating the broadcasting service from the access terminal to an access network;
(b) assigning by the access network a forward traffic channel for the broadcasting service in response to the request; and
(c) receiving by the access terminal the broadcasting service from the access network over the assigned forward traffic channel.

2. The method of claim 1, wherein step (a) comprises the step of transmitting, from the access terminal to the access network, a connection request message with a broadcast service ID field being set to a value indicating a simplex broadcasting service.

3. The method of claim 1, wherein step (a) comprises the step of transmitting, from the access terminal to the access network, a connection request message with a service type field being set to distinguishes a service type.

4. The method of claim 1, wherein step (b) comprises the step of transmitting, from the access network to the access terminal, a broadcast traffic channel assignment message including a broadcast service identifier indicating a channel for a simplex broadcasting service, and at least one of a broadcast medium access control (BMAC) index and a multicast medium access control (MMAC) index used for transmitting a simplex broadcast service packet.

5. The method of claim 1, wherein step (c) comprises the steps of:
(c1) setting up by the access terminal the forward traffic channel in response to the broadcast traffic channel assignment message, and transmitting a traffic channel complete message to the access network; and
(c2) transmitting by the access network an acknowledge (ACK) message for the traffic channel complete message to the access terminal, and transmitting broadcast traffic data to the access terminal over the set forward traffic channel.

6. The method of claim 5, wherein step (c2) comprises the steps of:
discarding a previous encoded packet and transmitting a broadcast service packet, if it is a broadcast service time and it is a retransmission time of the previous encoded packet; and
transmitting the broadcast service packet, if it is the broadcast service time and it is not the retransmission time of the previous encoded packet.

7. The method of claim 5, wherein step (c2) comprises the steps of:
retransmitting a previous encoded packet, if it is a retransmission time of a previous encoded packet;
selecting a new encoded packet through scheduling and transmitting the selected new encoded packet, if it is not the retransmission time of the previous encoded packet and it is not a broadcast service time; and
transmitting a broadcast service packet, if it is not the retransmission time of the previous encoded packet and it is the broadcast service time.

8. The method of claim 1, further comprising the steps of:
(d) sending by the access terminal a request for closing the broadcasting service to the access network while receiving the broadcasting service over the set forward traffic channel; and
(e) closing by the access network the broadcasting service for the access terminal in response to the broadcast service close request.

9. The method of claim 8, wherein step (d) comprises the step of transmitting, from the access terminal to the access network, a connection close message including a close reason field being set to a value indicating close of the broadcasting service or a value indicating release of a unicast traffic channel.

10. A method for providing a simplex broadcasting service to an access terminal in a high-speed wireless packet data communication system, comprising the steps of:
(a) sending a request for initiating the broadcasting service from the access terminal to an access network;
(b) assigning by the access network a forward traffic channel and a reverse traffic channel to the access terminal in response to the request;
(c) setting up a point-to-point protocol (PPP) connection for the broadcasting service through the forward traffic channel and the reverse traffic channel by the access terminal and the access network;
(d) receiving, by the access terminal, information necessary for the broadcasting service from the access network, and setting up a broadcast service channel using the received broadcast service information; and
(e) releasing by the access terminal the forward traffic channel and the reverse traffic channel, and receiving the broadcasting service over the set broadcast service channel.

11. The method of claim 10, wherein step (a) comprises the step of transmitting, from the access terminal to the access network, a connection request message including a broadcast service ID field being set to a value indicating a simplex broadcasting service.

12. The method of claim 10, wherein step (b) comprises the steps of:
(b1) transmitting by the access network a traffic channel assignment message for assigning the forward traffic channel and the reverse traffic channel, to the access terminal;
(b2) setting up by the access terminal the forward traffic channel and the reverse traffic channel in response to the traffic channel assignment message, and transmitting null data to the access network over the reverse traffic channel;
(b3) detecting by access network the null data from the reverse traffic channel and transmitting a reverse traffic channel acknowledge (ACK) message to the access terminal; and
(b4) transmitting by the access terminal a traffic channel complete message to the access network in response to the reverse traffic channel acknowledge message.

13. The method of claim 10, where in step (d) comprises the step of receiving by the access terminal a broadcast service information message including a broadcast service identifier indicating a channel for a simplex broadcasting service, and at least one of a broadcast medium access control (BMAC) index and a multicast medium access control (MMAC) index for transmitting a simplex broadcast service packet, from the access network.

14. The method of claim 10, wherein step (e) comprises the steps of:
(e1) transmitting, from the access terminal to the access network, a connection close message for releasing the forward traffic channel and the reverse traffic channel; and
(e2) releasing by the access network the forward traffic channel and the reverse traffic channel in response to the connection close message, and transmitting broadcast traffic data to the access terminal over the set broadcast service channel.

15. The method of claim 14, wherein step (e2) comprises the steps of:
discarding a previous encoded packet and transmitting a broadcast service packet, if it is a broadcast service time and it is a retransmission time of the previous encoded packet; and
transmitting the broadcast service packet, if it is the broadcast service time and it is not the retransmission time of the previous encoded packet.

16. The method of claim 14, wherein the step (e2) comprises the steps of:
retransmitting a previous encoded packet, if it is a retransmission time of the previous encoded packet;
selecting a new encoded packet through scheduling and transmitting the selected new encoded packet, if it is not the retransmission time of the previous encoded packet and it is not a broadcast service time; and
transmitting a broadcast service packet, if it is not the retransmission time of the previous encoded packet and it is the broadcast service time.

17. The method of claim 10, further comprising the steps of:
(f) sending by the access terminal a request for closing the broadcasting service to the access network while receiving the broadcasting service over the set broadcast service channel; and
(g) closing by the access network the broadcasting service for the access terminal in response to the broadcast service close request.

18. The method of claim 17, wherein step (f) comprises the step of transmitting, from the access terminal to the access network, a connection close message including a close reason field being set to one of a value indicating close of the broadcasting service or a value indicating release of a unicast traffic channel.

19. A method for providing a simplex broadcasting service to an access terminal in a high-speed wireless packet data communication system, comprising the steps of:
(a) transmitting information necessary for the broadcasting service from an access network to an access terminal;
(b) sending by the access terminal a request for initiating the broadcasting service to the access network using the broadcast service information;
(c) assigning by the access network a forward traffic channel and a reverse traffic channel to the access terminal in response to the request;
(d) setting up a point-to-point (PPP) connection for the broadcasting service through the forward traffic channel and the reverse traffic channel by the access terminal and the access network; and
(e) setting up by the access terminal a broadcast service channel using the broadcast service information, releasing the forward traffic channel and the reverse traffic channel, and then receiving the broadcasting service over the set broadcast service channel at the PPP connection.

20. The method of claim 19, wherein step (a) comprises the step of receiving by the access terminal a broadcast service information message including a broadcast service identifier indicating a channel for a simplex broadcasting service, and at least one of a broadcast medium access control (BMAC) index and a multicast medium access control (MMAC) index for transmitting a simplex broadcast service packet, from the access network.

21. The method of claim 19, wherein step (b) comprises the step of transmitting, from the access terminal to the access network, a connection request message including a broadcast service ID field indicating a channel for a simplex broadcasting service.

22. The method of claim 19, wherein step (c) comprises the steps of:
transmitting by the access network a traffic channel assignment message for assigning the forward traffic channel and the reverse traffic channel, to the access terminal;
setting up by the access terminal the forward traffic channel and the reverse traffic channel in response to the traffic channel assignment message, and transmitting null data over the reverse traffic channel;
detecting by the access network the null data from the reverse traffic channel, and transmitting a reverse traffic channel acknowledge (ACK) message to the access terminal; and
transmitting by the access terminal a traffic channel complete message to the access network in response to the reverse traffic channel acknowledge message.

23. The method of claim 19, wherein step (e) comprises the steps of:
(e1) transmitting a connection close message for releasing the forward traffic channel and the reverse traffic channel, from the access terminal to the access network;
(e2) releasing by the access network the forward traffic channel and the reverse traffic channel in response to the connection close message, and transmitting broadcast traffic data to the access terminal over the set broadcast service channel.

24. The method of claim 23, wherein step (e2) comprises the steps of:
discarding a previous encoded packet and transmitting a broadcast service packet, if it is a broadcast service time and it is a retransmission time of the previous encoded packet; and
transmitting the broadcast service packet, if it is the broadcast service time and it is not the retransmission time of the previous encoded packet.

25. The method of claim 23, wherein step (e2) comprises the steps of:
retransmitting a previous encoded packet, if it is a retransmission time of the previous encoded packet;
selecting a new encoded packet through scheduling and transmitting the selected new encoded packet, if it is not the retransmission time of the previous encoded packet and it is not a broadcast service time; and
transmitting a broadcast service packet, if it is not retransmission time of the previous encoded packet and it is the broadcast service time.

26. The method of claim 19, further comprising the steps of:
(f) sending by the access terminal a request for closing the broadcasting service to the access network while receiving the broadcasting service over the set broadcast service channel; and
(g) closing the broadcasting service for the access terminal in response to the broadcast service close request.

27. The method of claim 26, wherein step (f) comprises the step of transmitting, from the access terminal to the access network, a connection close message including a close reason field being set to one of a value indicating close of the broadcasting service or a value indicating release of a unicast traffic channel.
